(19) United States
(12) Patent Application Publication
(10) Pub. No.: US 2005/0243129 A1
(43) Pub. Date: Nov. 3, 2005

(54) Hydrophobic treatment method of nozzle plate used with ink jet head

(76) Inventor: Tae-kyun Kim, Yongin-si (KR)

Correspondence Address: STANZIONE & KIM, LLP, 919 18TH STREET, N.W., SUITE 440, WASHINGTON, DC, 20006, US

(21) Appl. No.: 11/004,917

(22) Filed: Dec. 7, 2004

(30) Foreign Application Priority Data
May 3, 2004 (KR) 2004-31128

(51) Int. Cl. B41J 2/165

(52) U.S. Cl. 347/45

(57) ABSTRACT

A hydrophobic treatment method of a nozzle plate used with an ink jet head includes preparing an ink jet head provided with a nozzle plate having a nozzle for ejecting ink, and forming a hydrophobic layer on the nozzle plate, the hydrophobic layer being formed of a silane compound containing a terminal functional group transformed to a hydrophilic functional group using a photochemical reaction. The silane compound is selectively exposed. In the hydrophobic treatment method, both a hydrophobic surface and a hydrophilic surface may be formed on one material layer.

### CROSS-REFERENCE TO RELATED APPLICATIONS

This application claims the benefit of Korean Patent Application No. 2004-31128, filed May 3, 2004, the disclosure of which is hereby incorporated herein by reference in its entirety.

### BACKGROUND OF THE INVENTION

1 . Field of the Invention

The present general inventive concept relates to a method of fabricating an ink jet head and, more particularly, to a hydrophobic treatment method of forming a nozzle plate used with an ink jet head.

2 . Description of the Related Art

An ink jet recording device functions to print an image by ejecting fine droplets of printing ink on a desired position of a recording medium. Such an ink jet recording device has been widely used due to an inexpensive price and characteristics capable of printing numerous kinds of colors at a high resolution. The ink jet recording device basically includes an ink jet head for substantially ejecting the ink and an ink container in fluid communication with the ink jet head. The ink stored in the ink container is supplied to the ink jet head through an ink feed hole, and then the ink jet head ejects the ink supplied from the ink container onto the recording medium to thereby perform printing. At this time, the ink is ejected to the recording medium through a nozzle formed at a nozzle plate.

In this process, an outlet portion of the nozzle is an important factor greatly affecting a droplet size and ejection performance of the ink ejected from the ink jet head. In particular, surface properties of the nozzle plate around the nozzle (hereinafter, referred to as “nozzle portion”) have a great influence on stability of the ink ejection and successive ejection of the ink. When a surface of the nozzle portion has hydrophilicity, the surface of the nozzle portion becomes wet as the ink ejection is repeatedly carried out. When the surface of the nozzle portion becomes wet, newly ejected ink is agglomerated with the ink remaining on the wet surface of the nozzle portion, thus being ejected in a flowing down manner without a perfect droplet shape. As a result, a printing quality deteriorates due to distortion of an ejecting direction of the ink and reduction of an ejecting speed of the ink, and a meniscus formed after the ink has been ejected also becomes unstable. In order to overcome the above-mentioned problems, an approach of forming a hydrophobic layer on the surface of the nozzle plate has been attempted. The hydrophobic layer generally adopts a silicone-based compound or a fluorine-based compound and, typically adopts a Teflon-based material, such as polytetra fluoro ethyleneglycol (PTFE). In this connection, methods of forming a hydrophobic layer on a surface of a nozzle plate are disclosed in Japanese Patent Publication Nos.: 1993-124199 and 1995-125219.

However, the methods of forming the hydrophobic layer on the nozzle plate have a problem required to be improved. That is, the hydrophobic layer is formed on the nozzle plate after forming a flow path structure including a nozzle plate. The hydrophobic layer may be formed by a contact printing method and a spin coating method using a porous material film containing a liquefied hydrophobic material. In this process, the hydrophobic material may be introduced into an unintended portion except the nozzle plate. That is, while forming the hydrophobic layer, the hydrophobic material may be introduced into a flow path of the ink jet head through the nozzle. The hydrophobic material introduced into the flow path causes an unintended hydrophobic layer to be formed in the flow path. The hydrophobic layer in the flow path introduces air bubbles into the flow path, and the air bubbles sticks thereto, thereby offsetting a pressure generated from a pressure-generating element and distorting the ejecting direction of the ink. Consequently, the hydrophobic layer in the flow path serves as a factor of deteriorating quality of the ink jet head.

### SUMMARY OF THE INVENTION

In order to solve the above and/or other problems, it is an aspect of the present general inventive concept to provide a hydrophobic treatment method of forming a nozzle plate used with an ink jet head capable of forming hydrophobic and hydrophilic surfaces on one material layer.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a hydrophobic treatment method of forming a nozzle plate used with an ink jet head capable of preventing a hydrophobic layer from being formed on an unintended region.

The foregoing and/or other aspects of the present general inventive concept may also be achieved by providing a hydrophobic treatment method of forming a nozzle plate used with an ink jet head. The method may include preparing an ink jet head provided with a nozzle plate having a nozzle for ejecting ink, and forming hydrophobic layer on the nozzle plate, the hydrophobic layer being formed of a silane compound containing a terminal functional group transformed to a hydrophilic functional group by means of a photochemical reaction. In an aspect of the present general inventive concept, the nozzle plate may have a structure having a nozzle through which the ink is ejected, and used in the ink jet head. In another aspect of the present general inventive concept, the silane compound may include chlorosilane, methoxysilane, ethoxysilane, trichlorosilane, trimethoxysilane, or triethoxysilane. In addition, the terminal functional group may include CF3CF2, CF3CH2, CH3, CH2=CH2, CF₃COO or CH3COO.

In another aspect of the present general inventive concept, the method may further include selectively exposing the silane compound after the silane compound is formed on the nozzle plate, so that a selective hydrophilic surface may be formed on the silane compound having hydrophobicity.

The foregoing and/or other aspect of the present general inventive concept may also be achieved by providing a hydrophobic treatment method of forming a nozzle plate used with an ink jet head, the method including forming a pressure-generating element for ink ejection on a substrate, forming on the substrate having the pressure-generating element a flow path structure having a sidewall structure for defining a sidewall of a flow path and a nozzle plate having a nozzle through which the ink is ejected, forming on the nozzle plate a hydrophobic layer formed of a silane compound containing a terminal functional group transformed to a hydrophilic functional group using a photochemical reaction, and exposing the silane compound introduced into the flow path through the nozzle in the process of forming the hydrophobic layer using a photomask provided with a pattern opening the nozzle.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 to 3 are cross-sectional views illustrating a hydrophobic treatment method of forming a nozzle plate used with an ink jet head according to an embodiment of the present general inventive concept;

FIG. 4 is an X-ray photoelectron spectroscopy (XPS) graph representing a change of surface properties of a silane compound according to an effect of exposure on the nozzle plate formed by the method shown in FIGS. 1 to 3; and

FIGS. 5A, 5B, and 5C are graphs representing a change of a hydrophobicity according to a pressure and a dose during an exposure process in the nozzle plate formed by the method shown in FIGS. 1 to 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

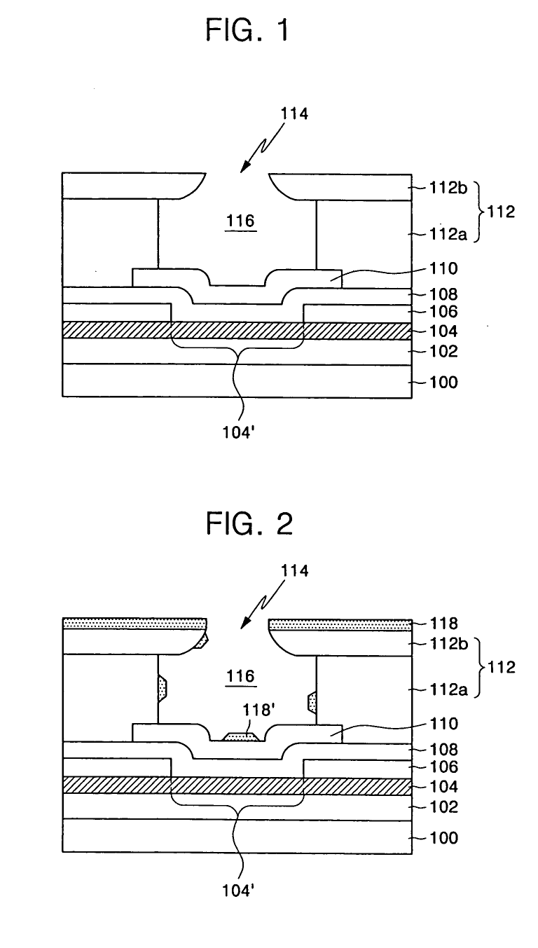

FIGS. 1 to 3 are cross-sectional views illustrating a hydrophobic treatment method of forming a nozzle plate used with an ink jet head according to an embodiment of the present general inventive concept.

Referring to FIG. 1, first, an ink jet head can be provided. The ink jet head may use an electro-thermal transducer as a pressure-generating element for ink ejection. However, the present general inventive concept is not limited thereto, and it may be widely applied to an ink jet head provided with a nozzle plate and a nozzle formed on the nozzle plate to eject ink. Hereinafter, a method of fabricating an ink jet head in accordance with an embodiment of the present general inventive concept will be described.

A heat barrier layer 102 can be formed on a substrate 100. The heat barrier layer 102 may be formed of a silicon dioxide (SiO2) layer. A heat-generating resistive layer and a conductive wiring layer can be sequentially formed on the heat barrier layer 102. The heat-generating resistive layer may be formed of a high resistive metal, such as a tantalum-aluminum alloy, by a sputtering method. In addition, the conductive wiring layer may be formed of a metal, such as aluminum, by the sputtering method or a chemical vapor deposition method. Next, the conductive wiring layer and the heat-generating resistive layer can be patterned to form a conductive wiring layer pattern and a heat-generating resistive layer pattern 104 which are sequentially stacked on the heat barrier layer 102. A process of patterning the conductive wiring layer and the heat-generating resistive layer may be performed by a conventional photolithography process and a dry etching process. Then, the conductive wiring layer pattern can be selectively removed to form interconnection lines 106 in order to expose a predetermined region of the heat-generating resistive layer pattern. As a result, a heat-generating resistor 104′ is defined in the heat-generating resistive layer pattern to correspond to a portion exposed by the interconnection lines 106. The process of selectively removing the conductive wiring layer pattern may be performed by a conventional photolithography process and a wet etching process. The heat-generating resistor 104′ can function as a pressure-generating element to eject the ink. A passivation layer 108 can be formed on the interconnection lines 106 and the heat-generating resistor 104′. The passivation layer 108 may be formed of a silicon dioxide layer, a silicon nitride layer or a silicon carbide layer. An anti-cavitation layer 110 can be formed on the passivation layer 108. The anti-cavitation layer 110 may be formed of a metal, such as Ta. As shown in FIG. 1, the anti-cavitation layer 110 may be formed to at least overlap with the heat-generating resistor 104′ by the patterning process.

Next, a flow path structure 112 can be formed on the substrate 100 having the heat-generating resistor 104′, the passivation layer 108 and the anti-cavitation layer 110. The flow path structure 112 may include a sidewall structure 112a to define sidewalls of a flow path 116 through which the ink supplied from an ink container is moved, and in which the ink is temporarily stored, and a nozzle plate 112b having a nozzle 114 to eject the ink. In this embodiment of the present general inventive concept, the nozzle plate 112b may be made of, but not limited to, a negative photosensitive polymer, a thermosetting polymer, or a metal. The flow path structure 112 may be formed in a hybrid or monolithic manner. In a case of forming the flow path structure 112 in the hybrid manner, the flow path structure 112 may be formed by forming the sidewall structure 112a on the substrate 100, manufacturing the nozzle plate 112b made of a metal, such as nickel, by a separate process, and attaching the nozzle plate 112b and the flow path structure 112 formed on the substrate 100 to each other. In an aspect of the present general inventive concept, the flow path structure 112 can be formed in the monolithic manner. For example, the flow path structure 112 may be formed in the monolithic manner as follows.

First, a negative photoresist can be formed on the substrate 100. The negative photoresist may be formed by a spin coating method using an epoxy-based photoresist, polyimid-based photoresist or polyacrylate-based photoresist. Next, a first exposure process using a photomask provided with a flow path pattern and a second exposure process using a photomask provided with a nozzle pattern can be sequentially performed. In this case, the second exposure process can be performed to expose an upper portion of the negative photoresist. Thus, a lower portion of the negative photoresisit is not exposed so that the flow path 116 is formed later. Then, the sidewall structure 112a for defining the sidewalls of the flow path 116 and the nozzle plate 112b having the nozzle 114 to eject the ink may be simultaneously formed by developing an unexposed portion of the negative photoresist.

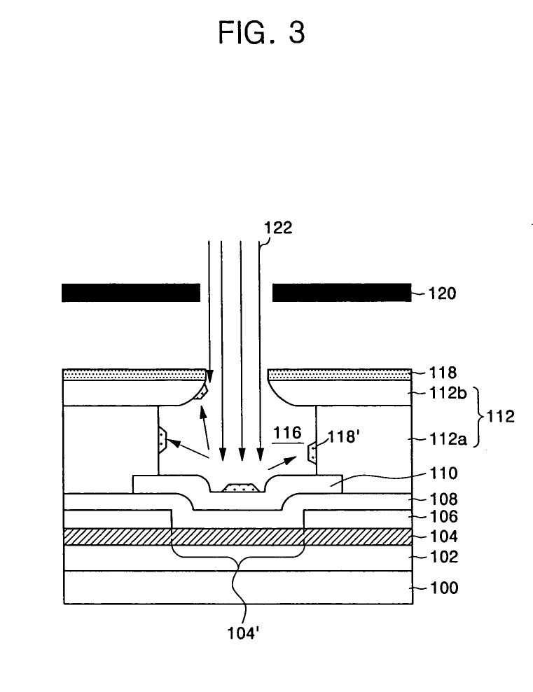

Referring to FIG. 2, a hydrophobic layer 118 can be formed on the nozzle plate 112b. In an aspect of the present general inventive concept, the hydrophobic layer 118 can be formed of a silane compound having a molecular weight equal to or less than about 500. In another aspect of the present general inventive concept, the silane compound may include chlorosilane, methoxysilane, ethoxysilane, trichlorosilane, trimethoxysilane, or trirthoxysilane. That is, the silane compound may have a typical straight chain structure and may have one or three chlorines, ethoxies or methoxies as a functional group reacting with a hydroxyl (OH) group. In addition, the silane compound may have a terminal functional group transformed into a hydrophilic functional group using a photochemical reaction. The terminal functional group may include CF3CF2, CF3CH2, CH3, CH2=CH2, CF₃COO, or CH3COO. For example, when the silane compound includes trichlorosilane containing CH3 as the terminal functional group, it can be represented as the following chemical formula 1.

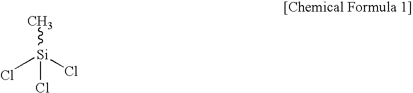

The hydrophobic layer 118 may be formed by a contact printing method, a spin coating method or a chemical vapor deposition method. At this time, the silane compound to be used may have a content of 0.01˜2 wt % in a solvent including alcohol, acetic acid, toluene and hexane.

As described above, when the nozzle plate 112b is the negative photoresist, such as the epoxy-based material, a surface of the nozzle plate 112b can absorb a water vapor in the atmosphere to contain a large quantity of hydroxyl groups. When the silane compound is applied on the nozzle plate 112b by the methods described above, the silane compound can form a semi-crystal structure through a covalent bond with the hydroxyl group on the surface of the nozzle plate 112b. The hydrophobic layer 118 formed by the above-described process can be strongly attached to the surface of the nozzle plate 112b and may have a thin thickness of about 10˜30 A. Therefore, before the hydrophobic layer 118 is formed on the nozzle plate 112b, the surface of the nozzle plate 112b is subjected to an oxidation treatment to further improve an adhesion between the nozzle plate 112b and the hydrophobic layer 118. In particular, when the nozzle plate 112b has a surface short of the hydroxyl group as in a metal, the oxidation treatment of the nozzle plate 112b can generate the hydroxyl group on the surface of the nozzle plate 112b to thereby improve the adhesion between the hydrophobic layer 118 and the nozzle plate 112b. The oxidation treatment on the surface of the nozzle plate 112b may be performed by dry oxidation treatment performed in a plasma atmosphere containing oxygen or wet oxidation treatment using vapor.

In an aspect of the present general inventive concept, a silane compound layer can be formed as the hydrophobic layer 118 on the nozzle plate 112b, and thereby it is possible to prevent the problems occurring due to the hydrophilicity of the surface of the nozzle plate 112b.

Meanwhile, the silane compound may be introduced into the flow path 116 through the nozzle 114, thus adhering to the flow path structure 112 in the flow path 116 or other structures on the substrate 100 in the process of forming the hydrophobic layer 118 on the nozzle plate 112b. Another hydrophobic material layer 118′ introduced into the flow path 116 can partially form a hydrophobic surface on inner walls of the flow path 116 to deteriorate the quality of the ink jet head.

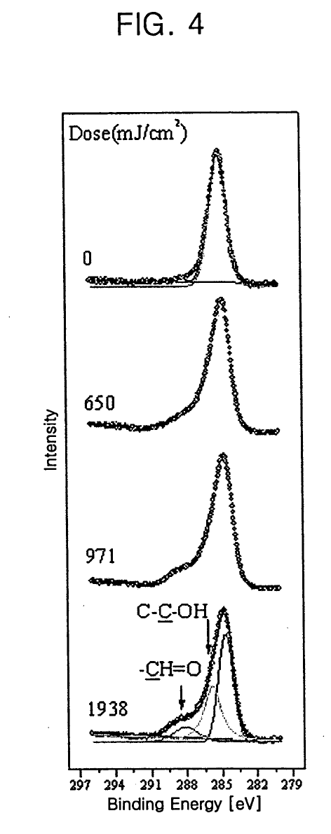

Referring to FIGS. 2 and 3, the silane compound as the hydrophobic layer 118 can be formed on the nozzle plate 112b, and then, selective exposure can be performed on the silane compound. The selective exposure is performed using a light source 122 in order to form a selective hydrophilic surface on the surface of the silane compound. As described above, the silane compound has the terminal functional group transformed into the hydrophilic functional group using the photochemical reaction. When UV-rays or X-rays are selectively irradiated to the silane compound, the terminal functional group of an exposed portion of the silane compound can be transformed into the hydrophilic functional group such as amine, hydroxyl, acetoxy or aldehyde, using the photochemical reaction through a surface reaction. As a result, the surface of the silane compound of the exposed portion can lose hydrophobicity to thereby gain the hydrophilicity. The selective exposure 122 of the silane compound may be performed by pattern exposure using a photomask provided with an exposure pattern. In an aspect of the present general inventive concept, the selective exposure can be performed to the introduced hydrophobic layer 118′ formed at the inner portion of the flow path 116, thus allowing the surface of the introduced hydrophobic layer 118′ to have the hydrophilicity. That is, as shown in FIG. 3, the UV-rays or the X-rays are irradiated into the inner portion of the flow path 116 using the photomask 120 provided with a pattern opening the nozzle 114. As a result, the introduced hydrophobic layer 118′ in the inner portion of the flow path 116 can be exposed directly or using scattering, and may have the hydrophilic surface using the photochemical reaction as described above. In this process, the hydrophilicity of the exposed portion can become larger as a pressure becomes higher and a dose of a light source becomes more during the exposure process. The dose of the light source may have a range of about 1˜5000 mJ/cm².

In an aspect of the present general inventive concept as described above, the selective exposure can be performed on the another hydrophobic material layer 118 introduced into an unintended region, i.e., the inner portion of the flow path 116 in the process of forming the hydrophobic layer 118 on the nozzle plate 112b. As a result, the surface of the another hydrophobic material layer 118′ in the flow path 116 may have the hydrophilicity, thereby preventing the formation of a hydrophobic surface in the flow path 116.

In an aspect of the present general inventive concept although the hydrophobic treatment method capable of preventing the hydrophobic surface in the flow path 116 from forming is described above, the present general inventive concept is not limited thereto. That is, the hydrophobic layer 118 can be formed on the nozzle plate 112b as the silane compound having the terminal functional group transformed to the hydrophilic functional group using the photochemical reaction, and then the hydrophobic layer 118 can be selectively exposed, so that the hydrophobic surface and the hydrophilic surface may be formed in a single material layer by a simple process. For example, a patterned hydrophobic layer may be formed on the nozzle plate 112b by performing the pattern exposure using the photomask to form the hydrophobic surface only at a portion around the nozzle 114 and to form the hydrophilic surface on the hydrophobic layer 118 at an outer portion of the nozzle 114.

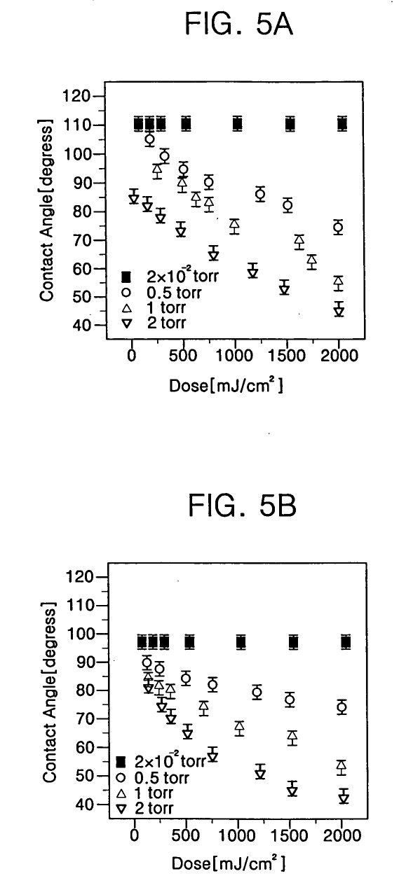

FIG. 4 is an X-ray photoelectron spectroscopy (XPS) graph representing a change of surface properties of a silane compound depending upon an exposure process in the ink jet head shown in FIGS. 1-3. A hydrophobic layer was formed of trichlorosilane containing CH₃ as a terminal functional group on a silicon substrate by a spin coating method.

Referring to FIG. 4, it can be found that hydroxyl and aldehyde were detected as the dose was increased. That is, it is represented that CH3 of the silane compound had been transformed to the hydroxyl or aldehyde as the hydrophilic functional group using the photochemical reaction.

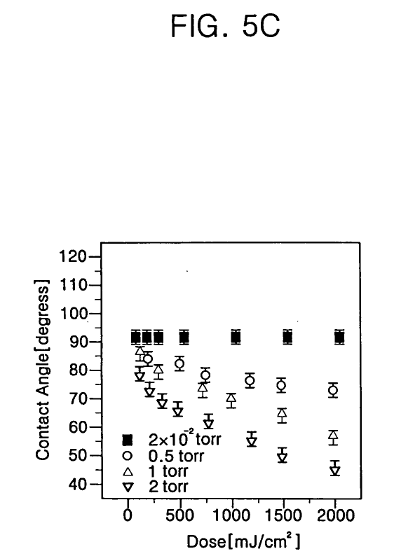

FIGS. 5A, 5B, and 5C are graphs representing a change of hydrophobicity depending upon pressure and a dose during the exposure in the ink jet head shown in FIGS. 1-3. The change of the hydrophobicity was indicated by a contact angle between ink and the silane compound layer. The graphs of FIGS. 5A, 5B, and 5C were obtained by performing X-ray exposure to a trichlorosilane layer containing CH₃, CH₂═CH₂ and CF₃COO, respectively, as a terminal functional group.

Referring to FIGS. 5A, 5B, and 5C, when the pressure during the exposure was 2×10⁻² torr, a contact angle was not decreased although the dose of the X-rays was increased. However, when the pressure during the exposure was increased and the dose of the X-rays was increased, the contact angle representing an ultra hydrophobicity of about 100 degrees was gradually decreased. Then, the contact angle represented about 40˜50 degrees when the exposure was performed under a pressure of about 2 torr and a dose of 2000 mJ/cm². This result shows that the hydrophilicity of the surface of the silane compound layer is improved as the pressure during the exposure and the dose of the X-rays are increased. In addition, it is anticipated that the hydrophilic surface having the contact angle equal to or less than 30 degrees may be more easily formed when the pressure during the exposure is the atmospheric pressure.

The hydrophobic treatment method of a nozzle plate used with ink jet head in accordance with the present general inventive concept as described above may form a hydrophobic surface and a hydrophilic surface on one material layer by a simple process.

In addition, the present general inventive concept may prevent the hydrophobic layer from forming at an unintended region in the process of forming the hydrophobic layer on the nozzle plate used with the ink jet head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A hydrophobic treatment method of forming a nozzle plate used with an ink jet head, comprising:
preparing an ink jet head having a nozzle plate and a nozzle formed on the nozzle plate to eject ink; and
forming a hydrophobic layer on the nozzle plate, the hydrophobic layer being formed of a silane compound containing a terminal functional group transformed into a hydrophilic functional group using a photochemical reaction.

2. The method according to claim 1, wherein the silane compound comprises any one selected from a group of chlorosilane, methoxysilane, ethoxysilane, trichlorosilane, trimethoxysilane, and triethoxysilane.

3. The method according to claim 2, wherein the terminal functional group comprises any one selected from a group of CF3CF2, CF3CH2, CH3, CH2=CH2, CF₃COO, and CH3COO.

4. The method according to claim 1, further comprising:
selectively exposing the silane compound formed on the nozzle plate to light.

5. The method according to claim 4, wherein the silane compound comprises any one selected from a group of chlorosilane, methoxysilane, ethoxysilane, trichlorosilane, trimethoxysilane, and triethoxysilane.

6. The method according to claim 5, wherein the terminal functional group comprises any one selected from a group of CF3CF2, CF3CH2, CH3, CH2=CH2, CF₃COO, and CH3COO.

7. The method according to claim 4, wherein the nozzle plate is formed of a negative photosensitive polymer or a thermosetting polymer.

8. The method according to claim 7, wherein the nozzle plate is formed of epoxy-based photoresist, polyimid-based photoresist, or polyacrylate-based photoresist.

9. The method according to claim 4, further comprising:
performing an oxidation treatment on a surface of the nozzle plate before forming the hydrophobic layer on the nozzle plate.

10. The method according to claim 9, wherein the nozzle plate is formed of a metal.

11. The method according to claim 4, wherein the exposing of the silane compound comprises exposing the silane compound to the light of a dose having a range of about 1˜5000 mJ/cm² inclusive.

12. A hydrophobic treatment method of forming a nozzle plate used with an ink jet head, the method comprising:
forming a pressure-generating element for ink ejection on a substrate;
forming a flow path structure on the substrate having the pressure-generating element, the flow path structure being formed to have a sidewalls structure to define a sidewall of a flow path, and a nozzle plate having a nozzle through which the ink is ejected;
forming a hydrophobic layer on the nozzle plate, the hydrophobic layer being formed of a silane compound containing a terminal functional group transformed to a hydrophilic functional group using a photochemical reaction; and
exposing the silane compound introduced into the flow path through the nozzle in a process of forming the hydrophobic layer using a photomask provided with a pattern opening the nozzle.

13. The method according to claim 12, wherein the silane compound comprises any one selected from a group of chlorosilane, methoxysilane, ethoxysilane, trichlorosilane, trimethoxysilane, and triethoxysilane.

14. The method according to claim 13, wherein the terminal functional group comprises any one selected from a group of CF3CF2, CF3CH2, CH3, CH2=CH2, CF₃COO, and CH3COO.

15. The method according to claim 12, wherein the nozzle plate is formed of a negative photosensitive polymer and a thermosetting polymer.

16. The method according to claim 15, wherein the nozzle plate is formed of epoxy-based photoresist, polyimid-based photoresist, or polyacrylate-based photoresist.

17. The method according to claim 12, further comprising:
performing an oxidation treatment to a surface of the nozzle plate before forming the hydrophobic layer on the nozzle plate.

18. The method according to claim 17, wherein the nozzle plate is formed of a metal.

19. The method according to claim 12, wherein the exposing of the silane compound comprises exposing the silane compound to the light of a dose having a range of about 1˜5000 mJ/cm².

20. A hydrophobic treatment method of forming an ink jet head, the method comprising:
forming a hydrophobic layer on a nozzle plate of a flow path structure and forming another hydrophobic layer on a surface defining a flow path pf the flow path structure; and
selectively exposing the another hydrophobic layer to form a hydrophilic surface.

21. The method according to claim 20, wherein the selectively exposing of the another hydrophobic layer comprises transforming a terminal functional group of the another hydrophobic layer to a hydrophilic functional group.

22. The method according to claim 20, wherein the forming of the hydrophobic layer and the another hydrophobic layer comprises forming the another hydrophobic layer on a portion other than a surface of the nozzle plate.

23. The method according to claim 20, wherein the selectively exposing of the another hydrophobic layer comprises exposing light on the another hydrophobic layer using a mask having an opening corresponding to the nozzle of the nozzle plate.

24. The method according to claim 20, wherein the selectively exposing of the another hydrophobic layer comprises preventing the hydrophobic layer from being exposed to the light.

25. A hydrophobic treatment method of forming an ink jet head, the method comprising:
forming a material layer on a flow path strucutre including a nozzle plate; and
forming a hydrophobic and a hydrophilic surfaces on the material layer.

26. The method according to claim 25, wherein the forming of the hydrophobic and hydrophilic surfaces comprises forming the hydrophobic surface on a first portion of the material layer and the hydrophilic surface on a second portion of the material layer.

27. The method according to claim 26, wherein the first portion of the material layer is an outer circumference surface of the material layer, and the second portion of the material layer is an inside surface of the material layer defining a flow path of an ink.

28. The method according to claim 26, wherein the nozle plate comprises a nozzle, and the first portion of the material layer is disposed an outer circumference surface of the material layer with respect to the nozzle, and the second portion of the material layer is an inside surface of the material layer defining a flow path of an ink with respect to the nozzle.

29. The method according to claim 25, wherein the material layer comprises a silane compound containing a terminal functional group to be transformed into a hydrophilic functional group using a photochemical reaction.

30. The method according to claim 29, wherein the photochemical reaction comprises a pressure and a dose of a light source.

31. An ink jet head, comprising:
a substrate structure;
a flow structure formed on the substrate structure and having a sidewall structure having a sidewall to define a flow path, a nozzle plate, and a nozzle formed on the nozzle plate to eject ink supplied through the flow path;
a hydrophobic surface formed on the nozzle plate; and
a hydrophilic surface formed on a portion of the sidewall of the side wall strucutre.

32. The ink jet head according to claim 31, wherein the hydrophobic surface and the hydrophilic suraface are formed of a silane compound containing a terminal functional group to be transformed into a hydrophilic functional group using a photochemical reaction.
